(19) United States
(12) Patent Application Publication
(10) Pub. No.: US 2011/0007072 A1
(43) Pub. Date: Jan. 13, 2011

(54) Systems and methods for three-dimensionally modeling moving objects

(75) Inventors: Saad M. Khan, Hamilton, NJ (US); Mubarak Shah, Oviedo, FL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: University of Central Florida Research Foundation, Inc., Orlando, FL (US)

(21) Appl. No.: 12/459,924

(22) Filed: Jul. 9, 2009

(51) Int. Cl. G06T 17/00

(52) U.S. Cl. 345/420

(57) ABSTRACT

In one embodiment, a system and method for three-dimensionally modeling a moving object pertain to capturing sequential images of the moving object from multiple different viewpoints to obtain multiple views of the moving object, identifying silhouettes of the moving object in each view, determining the location in each view of a temporal occupancy point for each silhouette boundary pixel, each temporal occupancy point being the estimated localization of a three-dimensional scene point that gave rise to its associated silhouette boundary pixel, generating blurred occupancy images that comprise silhouettes of the moving object composed of the temporal occupancy points, deblurring the blurred occupancy images to generate deblurred occupancy maps of the moving object, and reconstructing the moving object by performing visual hull intersection using the blurred occupancy maps to generate a three-dimensional model of the moving object.

### CROSS-REFERENCE TO RELATED APPLICATION

This application claims priority to co-pending U.S. non-provisional application entitled “Systems and Methods for Modeling Three-Dimensional Objects from Two-Dimensional Images” and having Ser. No. 12/366,241, filed Feb. 5, 2009, which is entirely incorporated herein by reference.

### NOTICE OF GOVERNMENT-SPONSORED RESEARCH

The disclosed inventions were made with Government support under Contract/Grant No.: NBCHCOB0105, awarded by the U.S. Government VACE program. The Government has certain rights in the claimed inventions.

### BACKGROUND

Traditionally, visual hull based approaches have been used to model three-dimensional objects. In such approaches, object silhouettes are obtained from multiple time-synchronized cameras or, if a single camera is used for a fly-by (or a turn table setup), the scene is assumed to be static. Those constraints generally limit the applicability of visual hull based approaches to controlled laboratory conditions. In real-life situations, a sophisticated multiple camera setup may not be practical. If a single camera is used to capture multiple views by going around the object, it is not reasonable to assume that the object will remain static over the course of time it takes to obtain the views of the object, especially if the object is a person, animal, or vehicle on the move. Although there has been some work on using visual hull reconstruction in monocular video sequences of rigidly moving objects to recover shape and motion, these methods involve the estimation of 6 degrees of freedom (DOF) rigid motion of the object between successive frames. To handle non-rigid motion, the use of multiple cameras becomes indispensable.

From the above, it can be appreciated that it would be desirable to have alternative systems and methods for three-dimensionally modeling moving objects.

### BRIEF DESCRIPTION OF THE FIGURES

The present disclosure may be better understood with reference to the following figures. Matching reference numerals designate corresponding parts throughout the figures, which are not necessarily drawn to scale.

FIG. 1A is a diagram that illustrates a bounding edge associated with a stationary object.

FIG. 1B is a diagram that illustrates a temporal bounding edge associated with a moving object.

FIG. 2 illustrates example images of a monocular sequence of an actual moving object.

FIG. 3 is a diagram that depicts imaging of a scene point in multiple different views by warping an image point corresponding to the scene point in a reference view to the other views with a homography induced by a plane that passes through the scene point.

FIGS. 4A-4C together comprise a flow diagram that illustrates an embodiment of a method for three-dimensionally modeling a moving object.

FIG. 5 illustrates multiple images of a monocular sequence of an example moving object.

FIG. 6 illustrates two example blurred occupancy images generated by locating temporal occupancy points corresponding to boundary silhouette pixels sampled from the images of FIG. 5.

FIG. 7 illustrates the effects of deblurring with respect to a moving arm of a blurred occupancy image.

FIG. 8 illustrates three example slices generated by performing visual hull intersection on deblurred images, the slices being overlaid onto a reference deblurred occupancy map.

FIG. 9 illustrates multiple views of a rendered object reconstruction for the moving object of FIG. 5 that results from the visual hull intersection.

FIG. 10 illustrates example images of multiple monocular sequences of a further moving object, wherein the object has a different posture in each sequence.

FIG. 11 illustrates example visual hull reconstructions generated from image data captured in the multiple monocular sequences.

FIG. 12 illustrates multiple views of a rendered object reconstruction for the moving object shown in FIG. 10.

FIG. 13 is a graph that plots similarity measures for conventional reconstruction and reconstruction according to the present disclosure.

FIG. 14 is an example system that can be used to perform three-dimensional modeling of moving objects

FIG. 15 illustrates an example architecture for a computer system shown in FIG. 14.

### DETAILED DESCRIPTION

### Introduction

Disclosed herein are systems and methods for three-dimensionally modeling, or reconstructing, moving objects, whether the objects are rigidly moving (i.e., the entire object is moving as a whole), non-rigidly moving (i.e., one or more discrete parts of the object are articulating or deforming), or both. The objects are modeled using the concept of motion-blurred scene occupancies, which is a direct analogy of motion-blurred two-dimensional images but in a three-dimensional scene occupancy space. Similar to a motion-blurred photograph resulting from the movement of a scene object or the camera capturing the photograph and the camera sensor accumulating scene information over the exposure time, three-dimensional scene occupancies are mixed with non-occupancies when there is motion, resulting in a motion-blurred occupancy space.

In some embodiments, an image-based fusion step that combines color and silhouette information from multiple views is used to identify temporal occupancy points (TOPs), which are the estimated three-dimensional scene locations of silhouette pixels and contain information about the duration of time the pixels were occupied. Instead of explicitly computing the TOPs in three-dimensional space, the projected locations of the TOPs are identified in each view to account for monocular video and arbitrary camera motion in scenarios where complete camera calibration information may not be available. The result is a set of blurred scene occupancy images in the corresponding views, where the values at each pixel correspond to the fraction of total time duration that the pixel observed an occupied scene location and where greater blur (lesser occupancy value) is interpreted as greater mixing of occupancy with non-occupancy in the total time duration. Motion deblurring is then used to deblur the occupancy images. The deblurred occupancy images correspond to silhouettes of the mean/motion compensated object shape and can be used to obtain a visual hull reconstruction of the object.

### Discussion of the Modeling Approach

Silhouette information has been used in the past to estimate occupancy grids for the purpose of object detection and reconstruction. Due to the inherent nature of visual hull based approaches, if the silhouettes correspond to a non-stationary object obtained at different time steps (e.g., monocular video), grid locations that are not occupied consistently will be carved out. As a result, the reconstructed object will only have an internal body core (consistently occupied scene locations) survive the visual hull intersection. An initial task is therefore to identify occupancy grid locations that are occupied by the scene object and to determine the durations that the grid locations are occupied. In essence, scene locations giving rise to the silhouettes in each view are to be estimated.

Obtaining Scene Occupancies

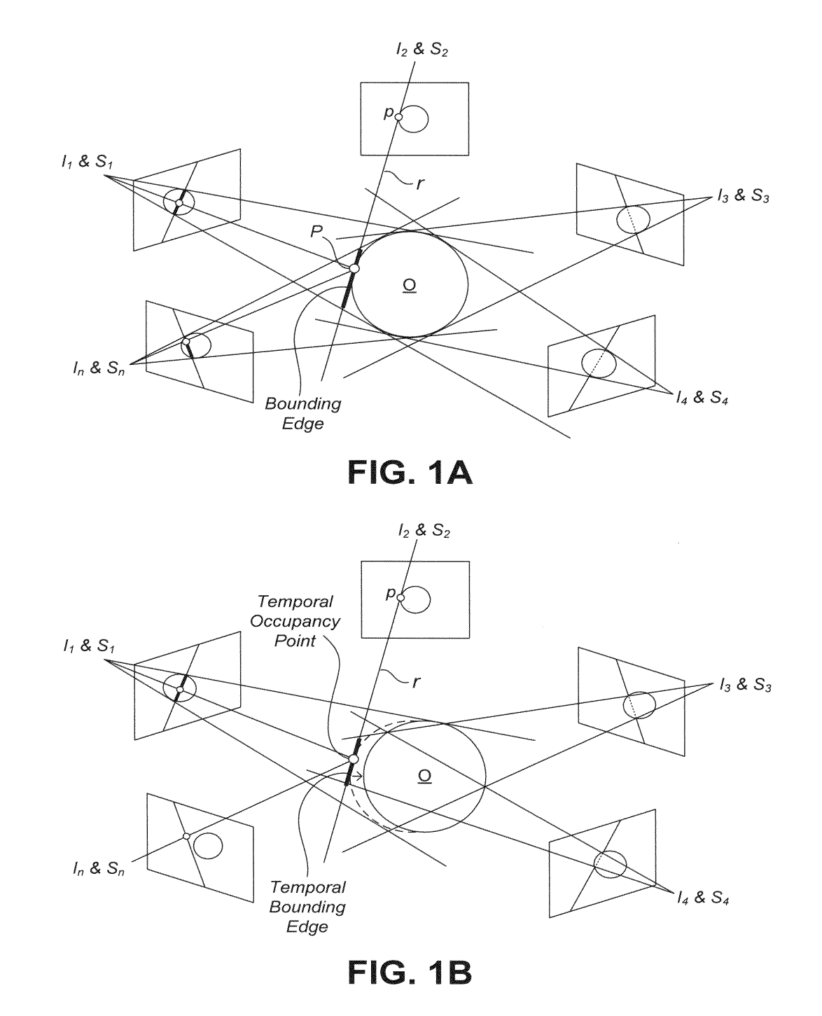

Let {Iₜ,Sₜ} be the set of color and corresponding foreground silhouette information generated by a stationary object O in T views obtained at times t=1 . . . , T in a monocular video sequence (e.g., a camera flying around the object). FIG. 1A depicts an example object O for purposes of illustration. Let pᵢ^{j} be a pixel in the foreground silhouette image Sᵢ. With the camera center of view i, pᵢ^{j} defines a ray rᵢ^{j} in three-dimensional space. If the object is stationary, then a portion of rᵢ^{j} is guaranteed to project inside the bounds of the object silhouettes in all the views. In previous literature, that portion of the ray has been referred to as the bounding edge. An example bounding edge is identified in FIG. 1A as the bold section of a ray r that intersects the edge of the object O at point P. Assuming the object to be Lambertian and the views to be color balanced, the three-dimensional scene point Pᵢ^{j} corresponding to pᵢ^{j} can be estimated by searching along the bounding edge for the point with minimum color variance when projected to the visible images.

If, however, object O is non-stationary, as depicted in FIG. 1B, and Pᵢ^{j} is not consistently occupied over the time period t=1: T, then rᵢ^{j} is no longer guaranteed to have a bounding edge. Specifically, there may be no point on rᵢ^{j} that projects to within object silhouettes in every view. In fact, there may be views where rᵢ^{j} projects completely outside the bounds of the silhouettes. This is the case for the lower left view in FIG. 1B. Since the views are obtained sequentially in time, the number of views in which rᵢ^{j} projects to within silhouette boundaries would in turn put an upper bound on the amount of time (with respect to total duration of video) Pᵢ^{j} is guaranteed to be occupied by O. Temporal occupancy τᵢ^{j} can be defined as the fraction of total time instances T (views) where rᵢ^{j} projects to within object silhouette boundaries, and a temporal bounding edge ξᵢ^{j} can be defined as the section of rᵢ^{j} that this corresponds to, as identified in FIG. 1B. Those concepts can be formally stated in the following proposition: For a silhouette point pᵢ that is the image of scene point Pᵢ, τᵢ^{j} provides an upper bound on the duration of time Pᵢ is guaranteed to be occupied and determines the temporal bounding edge ξᵢ^{j} on which Pᵢ must lie.

In the availability of scene calibration information, ξᵢ^{j} and τᵢ^{j} can be obtained by successively projecting rᵢ^{j} in the image planes and retaining the section that projects to within the maximum number of silhouette images. To refine the localization of the three-dimensional scene point Pᵢ^{j} (corresponding to the silhouette pixel pᵢ^{j}) along ξᵢ^{j}, another construct called the temporal occupancy point (TOP) is used. The temporal occupancy point is obtained by enforcing an appearance/color constancy constraint as described in the next section.

### Temporal Occupancy Points

If the views of the object are captured at a rate faster than its motion, then without loss of generality, a non-stationary object O can be considered to be piecewise stationary: O={O_{1:s}_{₁}, Oₛ_{₁}_{+1:s}_{₂}, . . . , Oₛ_{ₖ}_{:T}}, where each Sᵢ marks a time where there is motion in the object. This assumption is easily satisfied in high capture rate videos in which small batches of frames of non-stationary objects tend to be rigid. With the previous assumptions of Lambertian surfaces and color balanced views, having piecewise stationary would justify a photo-consistency check along the temporal bounding edge for scene point localization. A linear search can be performed along the temporal bounding edge ξᵢ^{j} for a point that touched the surface of the object. Such a point will have the property that its projection in the visible images (i.e., images in which the temporal bounding edge is within the silhouette) has minimum color variance. That point is the temporal occupancy point (see FIG. 1B), which can be used as the estimated localization of the three-dimensional scene point Pᵢ^{j} that gave rise to the silhouette pixel Pᵢ^{j}.

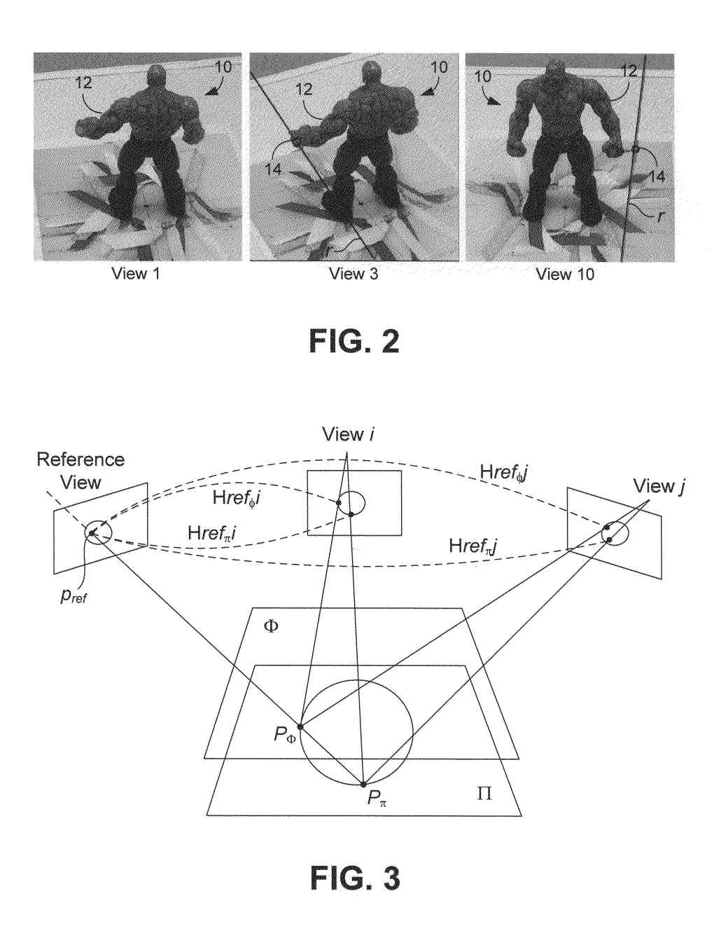

The above-described process is demonstrated on an actual moving object 10 in FIG. 2. FIG. 2 shows three views, Views 1, 3, and 10, of multiple views captured in a monocular camera flyby sequence as the left arm 12 of the object 10 moved. Pixel p in View 1, which corresponds to the object's left hand, was selected for demonstration. The three-dimensional ray r back-projected through pixel p was imaged in Views 3 and 10. Due to the motion of the object 10 (left arm 12 moving down) in the time duration between Views 1 and 10, the ray r does not pass through the corresponding left hand pixel in View 10. Instead, the projection of the ray r is completely outside the bounds of the object silhouette in View 10. The temporal bounding edges and the temporal occupancy points corresponding to pixel p were computed and their projections 14, 16 are shown in Views 3 and 10, respectively.

Because monocular video sequences are used, it may not be the case that there is complete camera calibration at each time instant, particularly if the camera motion is arbitrary. For that reason, a purely image-based approach is used. Instead of determining each silhouette's corresponding temporary occupancy point explicitly in three-dimensional space, the projections (images) of the temporary occupancy point is obtained for each view. If the object was stationary and the scene point was visible in every view, then a simple stereo-based search algorithm could be used. Given the fundamental matrices between views, the ray through a pixel in one view can be directly imaged in other views using the epipolar constraint. The images of the temporary occupancy point can then be obtained by searching along the epipolar lines (in the object silhouette regions) for a correspondence across views that has minimum color variance. However, when the object is not stationary and the scene point is therefore not guaranteed to be visible from every view, a stereo-based approach is not viable. It is therefore proposed that homographies induced between the views by a pencil of planes for a point-to-point transformation be used instead.

With reference to FIG. 3, the image of the three-dimensional scene point Pφ (corresponding to the image point P_{ref} in the reference view) can be directly obtained in other views by warping P_{ref} with the homography induced by a plane φ that passes through Pφ. A ground plane reference system can be used to obtain that homography. Given the homography induced by a scene ground plane and the vanishing point of the normal direction, homographies of planes parallel to the ground plane in the normal direction can be obtained using the following relationship:

$${H}_{{i}_{φ} j} = ( {H}_{{i}_{π} j} + [ O \vert γ {v}_{ref} ] ) ( {I}_{3 \times 3} - \frac{1}{1 + γ} [ O \vert γ {v}_{ref} ] ) . \qquad [ Equation 1 ]$$

The parameter γ determines how far up from the reference plane the new plane is. The projection of the temporal bounding edge ξᵢ^{j} in the image planes can be obtained by warping pᵢ^{j} with homographies of successively higher planes (by incrementing the value of γ) and selecting the range of γ for which pᵢ^{j} warps to within the largest number of silhouette images. The image of pᵢ^{j}'s temporary occupancy point in all the other views is then obtained by finding the value of γ in the previously determined range, for which pᵢ^{j} and its homographically warped locations have minimum color variance in the visible images. The upper bound on occupancy duration τᵢ^{j} is evaluated as the ratio of the number of views where ξᵢ^{j} projects to within silhouette boundaries and the total number of views. This value is stored for each imaged location of pᵢ^{j}'s temporary occupancy point in every other view.

Building Blurred Occupancy Images

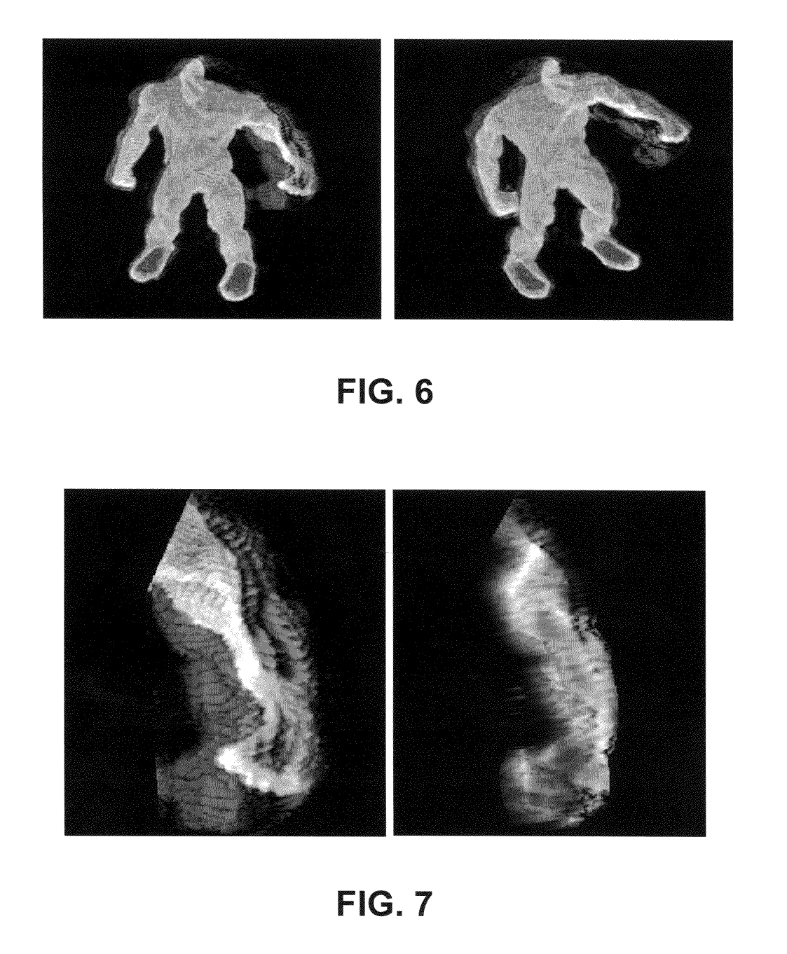

As described above, the image location of a silhouettes pixel's temporal occupancy point can be obtained in every other view. The boundary of the object silhouette in each view can be uniformly sampled and their temporary occupancy points can be projected in all the views. The accumulation of the projected temporary occupancy points delivers a corresponding set of images referred to herein as blurred occupancy images: Bₜ; t=1, . . . , T. Example blurred occupancy images are shown in FIG. 6, described below, in which the analogy to motion-blurred images is readily apparent. The pixel values in each image are the occupancy durations τ of the temporal occupancy points. Due to the motion of the object, regions in space are not consistently occupied, resulting in some occupancies blurred out with non-occupancies. An example procedure for generating blurred occupancy images can be described by the following algorithm:
for each silhouette image:
   Uniformly sample silhouette boundary
   for each sampled silhouette pixel p:
      1. Obtain temporal bounding edge ξ and occupancy duration τ
         Transform p to other views using multiple plane homographies.
         Select range of γ (planes) for which p warps to within the silhouette boundaries of the largest number of views.
      2. Find projected location of TOP in all other views
         Search along ξ (values of plane γ)
         Project point to visible views
         Return if minimum variance in appearance amongst the views.
      3. Store value τ at projected locations of TOP in each Bₜ.
   End for.
End for.

Motion Deblurring

The motion blur in the blurred occupancy images can be modeled as the convolution of a blur kernel with the latent occupancy image plus noise:

B=L [symbol] K+n, [Equation 2]

where B is the blurred occupancy image, L is the latent or unblurred occupancy image, K is the blur kernel also known as the point spread function (PSF), and n is additive noise. Conventional blind deconvolution approaches focus on the estimate of K to deconvolve B using image intensities or gradients. In traditional images, there is the additional complexity that may be induced by the background, which may not undergo the same motion as the object. The PSF has a uniform definition only on the moving object. This however is not a factor for the present case since the information in the blurred occupancy images corresponds only to the motion of the object. Therefore, the foreground object can be segmented as a blurred transparency layer and the transparency information can be used in a MAP (maximum a-priori) framework to obtain the blur kernel. By avoiding taking all pixel colors and complex image structures into computation, this approach has the advantage of simplicity and robustness but requires the estimation of the object transparency or alpha matte. The object occupancy information in the blurred occupancy maps, once normalized in the [0-1] range, can be directly interpreted as the transparency information or an alpha matte of the foreground object.

The blur filter estimation maximizes the likelihood that the resulting image, when convolved with the resulting PSF, is an instance of the blurred image, assuming Poisson noise statistics. The process deblurs the image and refines the PSF simultaneously, using an iterative process similar to the accelerated, damped Lucy-Richardson algorithm. An initial guess of the PSF can be simple translational motion. That is then fed into the blind deconvolution approach that iteratively restores the blurred image and refines the PSF to deliver deblurred occupancy maps Lₜ; t=1, . . . , T, which are used in the final reconstruction.

It should be noted that the above-described deblurring approach assumes uniform motion blur. However, that may not always be the case in natural scenes. For instance, due to the difference in motion between the arms and the legs of a walking person, the blur patterns in occupancies may be different and hence different blur kernels may be needed to be estimated for each section. Because of the challenges that involves, a user may instead specify different crop regions of the blurred occupancy images, each with uniform motion, that can be restored separately.

Final Reconstruction

Once motion deblurred occupancy maps have been generated, the final step is to perform a probabilistic visual hull intersection. Existing approaches can be used for that purpose. In some embodiments, the approach described in related U.S. patent application Ser. No. 12/366,241 (“the Khan approach”) is used to perform the visual hull intersection given that it handles arbitrary camera motion without requiring full calibration. In the Khan approach, the three-dimensional structure of objects is modeled as being composed of an infinite number of cross-sectional slices, with the frequency of slice sampling being a variable determining the granularity of the reconstruction. Using planar homographies induced between views by a reference plane (e.g., ground plane) in the scene, occupancy maps LᵢS′ (foreground silhouette information) from all the available views are fused into an arbitrarily chosen reference view performing visual hull intersection in the image plane. This process delivers a two-dimensional grid of object occupancy likelihoods representing a cross-sectional slice of the object. Consider a reference plane π in the scene inducing homographies Hᵢ_{_{π}}ⱼ, from view i to view j. By warping LᵢS′ to an occupancy map in a reference view L_{ref}, obtained are warped occupancy maps: îᵢ=[Hᵢ_{_{π}}ⱼLᵢ]. Visual hull intersection on π is achieved by fusing the warped occupancy maps:

$${θ}_{ref} = {\prod }_{i = 1}^{n} {\hat{L}}_{i} , \qquad [ Equation 3 ]$$

where θ_{ref} is the projectively transformed grid of object occupancy likelihoods, or an object slice. Significantly, using this homographic framework, visual hull intersection is performed in the image plane without going into three-dimensional space.

Subsequent slices or θs of the object are obtained by extending the process to planes parallel to the reference plane in the normal direction. Homographies of those new planes can be obtained using the relationship in Equation 3. Occupancy grids/slices are stacked on top of each other, creating a three dimensional data structure: Θ=[θ₁; θ₂; . . . θₙ] that encapsulates the object shape. Θ is not an entity in the three-dimensional world or a collection of voxels. It is, simply put, a logical arrangement of planar slices representing discrete samplings of the continuous occupancy space. Object structure is then segmented out from Θ, i.e., simultaneously segmented out from all the slices, by evolving a smooth surface S: [0,1]→ [symbol] using level sets that divides Θ between the object and the background.

### Application of the Modeling Approach

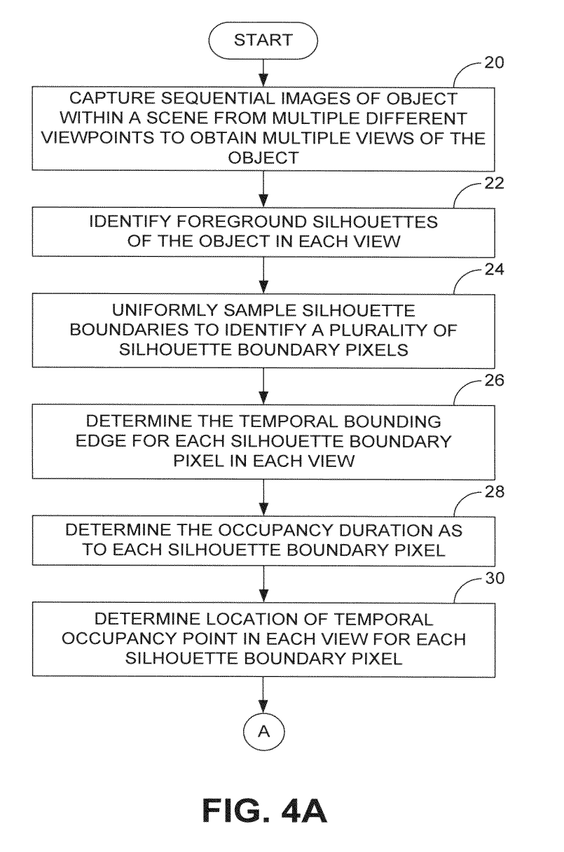

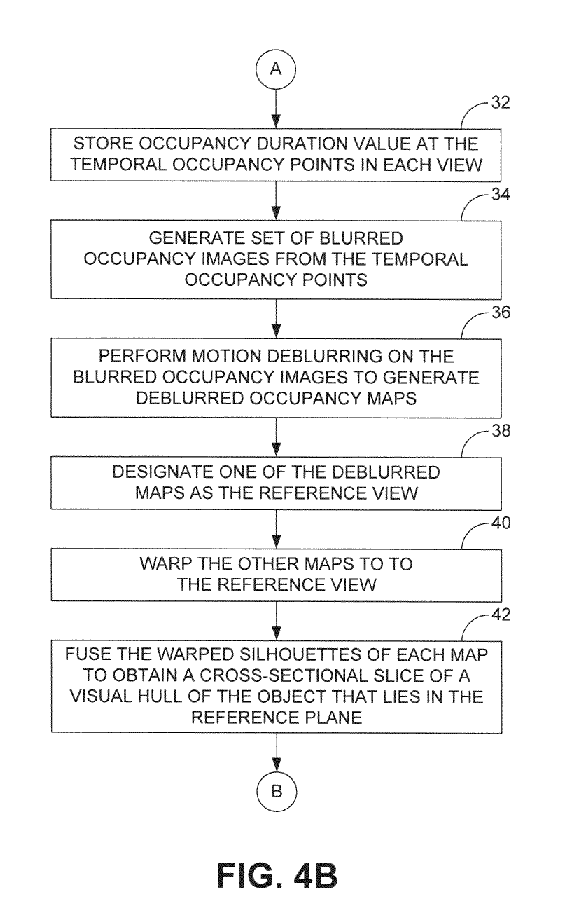

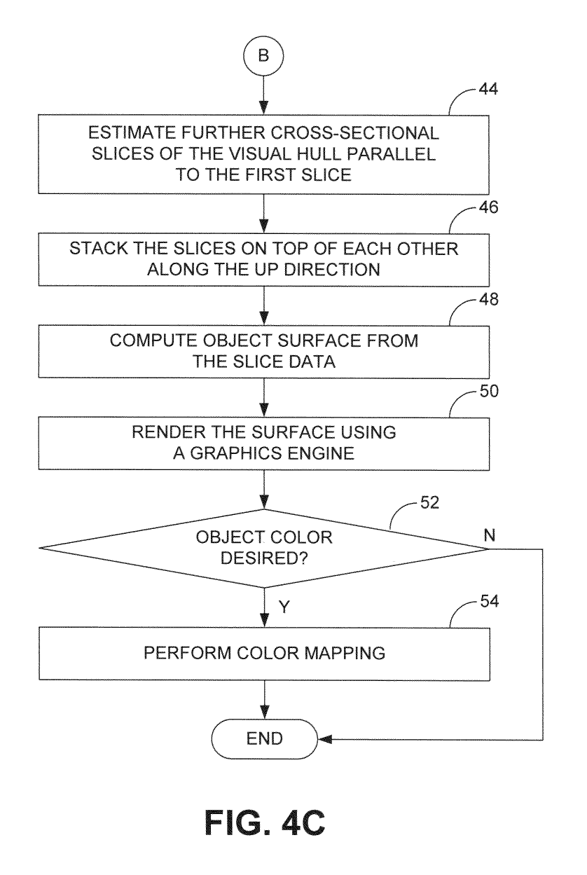

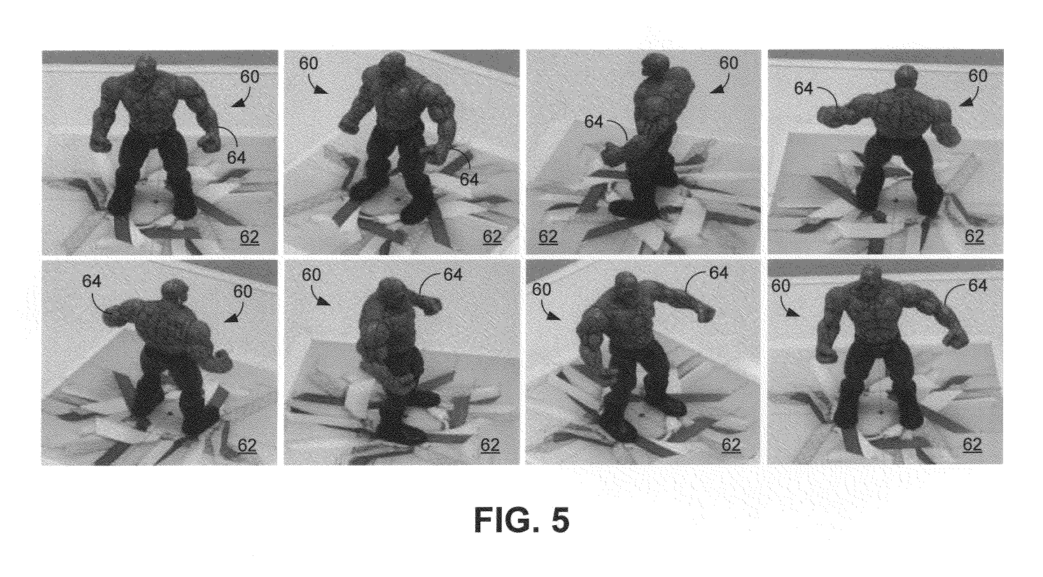

Application of the above-described approach will now be discussed with reference to the flow diagram of FIGS. 4A-4C, as well as FIGS. 5-9. More particularly, discussed is an example embodiment of a method of three-dimensionally modeling a moving object. Beginning with block 20 of FIG. 4A, multiple images of an object within a scene are captured from multiple different viewpoints to obtain multiple views of the object. The images can be captured by multiple cameras, for example positioned in various fixed locations surrounding the object. Alternatively, the images can be captured using a single camera. In the single camera case, the camera can be moved about the object in a flyby scenario, or the camera can be fixed and the object can be rotated in front of the camera, for example on a turntable. Irrespective of the method used to capture the images, the views are preferably uniformly spaced through 360 degrees to reduce reconstruction artifacts. Generally speaking, the greater the number of views that are obtained, the more accurate the reconstruction of the object. The number of views that are necessary may depend upon the characteristics of the object. For instance, the greater the curvature of the object, the greater the number of views that will be needed to obtain desirable results.

FIG. 5 illustrates eight example images of an object 60, in this case an articulable action figure, with each image representing a different view of the object. In an experiment conducted using the object 60, 20 views were obtained using a single camera that was moved about the object in a flyby. The object 60 was supported by a support surface 62, which may be referred to as the ground plane. As is apparent from each of the images, the ground plane 62 has a visual texture that comprises optically detectable features, which can be used for feature correspondence between the various views. The particular nature of the texture is of relatively little importance, as long as it comprises an adequate number of detectable features. Therefore, the texture can be an intentional pattern, whether it be a repeating or non-repeating pattern, or a random pattern. As can be appreciated through comparison of the images, the left arm 64 of the object 60 was laterally raised as the sequence of images was captured. Accordingly, the left arm 64 began at an initial, relatively low position (upper left image), and ended at a final, relatively high position (lower right image).

With reference back to FIG. 4A, once all the desired views have been obtained, the foreground silhouettes of the object in each view are identified, as indicated in block 22. The manner in which the silhouettes are identified may depend upon the manner in which the images were captured. For example, if the images were captured with a single or multiple stationary cameras, identification of the silhouettes can be achieved through image subtraction. To accomplish this, images can be captured of the scene from the various angles from which the images of the object were captured, but without the object present in the scene. Then the images with the object present can be compared to those without the object present as to each view to identify the boundaries of the object in every view.

Image subtraction typically cannot be used, however, in cases in which the images were captured by a single camera in a random flyby of an object given that it is difficult to obtain the same viewpoint of the scene without the object present. In such a situation, image alignment can be performed to identify the foreground silhouettes. Although consecutive views can be placed in registration with each other by aligning the images with respect to detectable features of the ground plane, such registration results in the image pixels that correspond to the object being misaligned due to plane parallax. This misalignment can be detected by performing a photo-consistency check, i.e., comparing the color values of two consecutive aligned views. Any pixel that has a mismatch from one view to the other (i.e., the color value difference is greater than a threshold) is marked as a pixel pertaining to the object.

The alignment between such views can be determined, by finding the transformation, i.e., planar homography, between the views. In some embodiments, the homography can be determined between any two views by first identifying features of the ground plane using an appropriate algorithm or program, such as scale-invariant feature transform (SIFT) algorithm or program. Once the features have been identified, the features can be matched across the views and the homographies can be determined in the manner described above. By way of example, at least four features are identified to align any two views. In some embodiments, a suitable algorithm or program, such as a random sample consensus (RANSAC) algorithm or program, can be used to ensure that the identified features are in fact contained within the ground plane.

Once the silhouettes of the object have been identified, the boundary (i.e., edge) of each silhouette is uniformly sampled to identify a plurality of silhouette boundary pixels (p), as indicated in block 24. The number of boundary pixels that are sampled for each silhouette can be selected relative to the results that are desired and the amount of computation that will be required. Generally speaking, however, the greater the number of silhouette boundary pixels that are sampled, the more accurate the reconstruction of the object will be. By the way of example, one may sample one pixel for every 8 pixel neighborhood.

Referring next to block 26, the temporal bounding edge (ξ) is determined for each silhouette boundary pixel of each view. As described above, the temporal bounding edge is the portion of a ray (that extends from an image point (p) to its associated three-dimensional scene point (P)) that is within the silhouette image of a maximum number of views. In some embodiments, the temporal bounding edge for each silhouette boundary pixel can be determined by transforming the pixel to each of the other views using multiple plane homographies as per Equation 1. In such a process, each pixel is warped with the homographies induced by a pencil of planes starting from the ground reference plane and moving to successively higher parallel plans (φ) by incrementing the value of γ. The range of γ for which the boundary pixel homographically warps to within the largest number of silhouette images is then selected, thereby delineating the temporal bounding edge of the silhouette boundary pixel.

Once the temporal bounding edge for each silhouette boundary pixel has been determined, the occupancy duration (τ) as to each silhouette boundary pixel can likewise be determined, as indicated in block 28. As described above, the occupancy duration is the ratio of the number of views in which the temporal bounding edge projects to within silhouette boundaries and the total number of views.

Next, with reference to block 30, the location of the temporal occupancy point in each view is determined for each silhouette boundary pixel. As described above, the temporal occupancy point is the point along the temporal bounding edge that most closely estimates the localization of the three-dimensional scene point that gave rise to the silhouette boundary pixel. In some embodiments, the temporal occupancy point is determined by finding the value of γ in the previously-determined range of γ for which the silhouette boundary pixel and its graphically warped locations have minimum color variance in the visible images. As mentioned above, if the object is piecewise stationary, it can be assumed that the object is static and a photo-consistency check can be performed to identify the temporal occupancy point. Once the temporal occupancy points have been determined, the occupancy duration values at the temporal occupancy points in each view can then be stored, as indicated in block 32 of FIG. 4B.

Once the temporal occupancy point has been determined for each silhouette boundary pixel in each view, the temporal occupancy points can be used to generate a set of blurred occupancy images, as indicated in block 34. The set will comprise one blurred occupancy image for each view of the object. FIG. 6 illustrates two example blurred occupancy images corresponding to pixels sampled from the images illustrated in FIG. 5. As can be appreciated from FIG. 6, the sections of the scene through which the moving arm 64 passed are not consistently occupied, resulting in a blurring of the arm in the image. The pixel values, in terms of pixel intensity, in each blurred occupancy image are the occupancy duration values that were stored in block 32 (i.e., the temporal durations of the temporal occupancy points).

Next, with reference to block 36, motion deblurring is performed on the blurred occupancy images to generate deblurred occupancy maps. In some embodiments, deblurring comprises segmenting the foreground object as a blurred transparency layer and using the transparency information in a MAP framework to obtain the blur kernel. In that process, an initial guess for the PSF is fed into a blind deconvolution approach that iteratively restores the blurred image and refines the PSF to deliver the deblurred occupancy maps. FIG. 7 illustrates the effect of such deblurring. In particular, FIG. 7 shows the moving arm of the object in a blurred occupancy image (left image) before and in a deblurred occupancy map (right image). As can be appreciated from that figure, deblurring removes much of the phantom images of the arm.

Once the deblurred occupancy maps have been obtain, visual hull intersection can be performed to generate the object model or reconstruction. For the present embodiment, it is assumed that visual hull intersection is performed using the procedure described in related U.S. patent application Ser. No. 12/366,241 in which multiple slices of the object are estimated, and the slices are used to compute a surface that approximates the outer surface of the object.

With reference to block 38, one of the deblurred occupancy maps is designated as the reference view. Next, each of the other maps is warped to the reference view relative to the reference plane (e.g., ground plane), as indicated in block 40. That is, the various maps are transformed by obtaining the planar homography between each map and the reference view that is induced by the reference plane. Notably, those homographies can be obtained by determining the homographies between consecutive maps and concatenating each of those homographies to produce the homography between each of the maps and the reference view. Such a process may be considered preferable given that it may reduce error that could otherwise occur when homographies are determined between maps that are spaced far apart from each other.

After each of the maps, and their silhouettes, has been transformed (i.e., warped to the reference view using the planar homography), the warped silhouettes of each map are fused together to obtain a cross-sectional slice of a visual hull of the object that lies in the reference plane, as indicated in block 42. That is, a first slice of the object (i.e., a portion of the object that is occluded from view) that is present at the ground plane is estimated.

The above process can be replicated to obtain further slices of the object that lie in planes parallel to the reference plane. Given that those other planes are imaginary, and therefore comprise no identifiable features, the transformation used to obtain the first slice cannot be performed to obtain the other slices. However, because the homographies induced by the reference plane and the location of the vanishing point in the up direction are known, the homographies induced by any plane parallel to the reference plane can be estimated. Therefore, each of the views can be warped to the reference view relative to new planes, and the warped silhouettes that result can be fused together to estimate further cross-sectional slices of the visual hull, as indicated in block 44 of FIG. 4C.

As described above, the homographies can be estimated using Equation 1 in which γ is a scalar multiple that specifies the locations of other planes along the up direction. Notably, the value for γ can be selected by determining the range for γ that spans the object. This is achieved by incrementing γ in Equation 1 until a point is reached at which there is no shadow overlap, indicating that the current plane is above the top of the object. Once the range has been determined, the value for γ at that point can be divided by the total number of planes that are desired to determine the appropriate value of γ to use. For example, if γ is 10 at the top of the object and 100 planes are desired, γ can be set to 0.1 to obtain the homographies induced by the various planes.

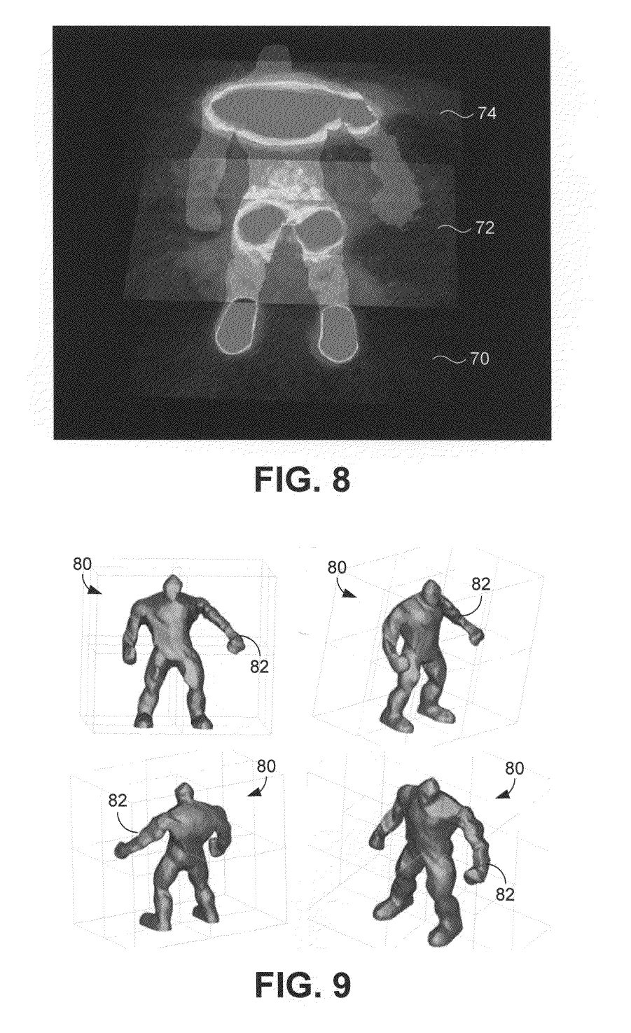

At this point in the process, multiple slices of the object have been estimated. FIG. 8 illustrates three example slices (identified by reference numerals 70-74) of 100 generated slices overlaid onto a reference deblurred occupancy map. As with the number of views, the greater the number of slices, the more accurate the results that can be obtained.

Once the slices have been estimated, their precise boundaries are still unknown and, therefore, the precise boundaries of the object are likewise unknown. One way in which the boundaries of the slices could be determined is to establish thresholds for each of the slices to separate image data considered part of the object from image data considered part of the background. In the current embodiment, however, the various slices are first stacked on top of each other along the up direction, as indicated in block 46 of FIG. 4C to generate a three-dimensional “box” (i.e., the data structure Θ) that encloses the object and the background. At that point, a surface can be computed that divides the three-dimensional box into the object and the background to segment out the object surface. In other words, an object surface can be computed from the slice data, as indicated in block 48.

As described in related U.S. patent application Ser. No. 12/366,241, the surface can be computed by minimizing an energy function that comprises a first term that identifies portions of the data that have high gradient (thereby identifying the boundary of the object) and the second term identifies the surface area of the object surface. By minimizing both terms, the surface is optimized as a surface that moves toward the object boundary and has as small a surface area as possible. In other words, the surface is optimized to be the tightest surface that divides the three-dimensional surface of the object from the background.

After the object surface has been computed, the three-dimensional locations of points on the surface are known and, as indicated in block 50, the surface can be rendered using a graphics engine. FIG. 9 illustrates multiple views of an object reconstruction 80 that results when such rendering is performed. In that figure, the moving arm 64 is preserved as arm 82. Although there is some loss of detail for the arm 82, that loss was at least in part due to the limited number of views (i.e., 20) that were used. Generally speaking, the arm 82 of the reconstruction 80 represents a mean position or shape of the moving arm 64 during its motion. For that reason, the arm 82 has a middle position as compared to the initial and final positions of the moving arm 64 (see the top left and bottom right images of FIG. 5).

At this point, a three-dimensional model of the object has been produced, which can be used for various purposes, including object localization, object recognition, and motion capture. It can then be determined whether the colors of the object are desired, as indicated in decision block 52 of FIG. 4C. If not, flow for the process is terminated. If so, however, the process continues to block 54 at which color mapping is performed. In some embodiments, color mapping can be achieved by identifying the color values for the slices from the outer edges of the slices, which correspond to the outer surface of the object. A visibility check can be performed to determine which of the pixels of the slices pertain to the outer edges. Specifically, pixels within discrete regions of the slices can be “moved” along the direction of the vanishing point to determine if the pixels move toward or away from the center of the slice. The same process is performed for the pixels across multiple views and, if the pixels consistently move toward the center of the slice, they can be assumed to comprise pixels positioned along the edge of the slice and, therefore, at the surface of the object. In that case, the color values associated with those pixels can be applied to the appropriate locations on the rendered surface.

### Quantitative Analysis

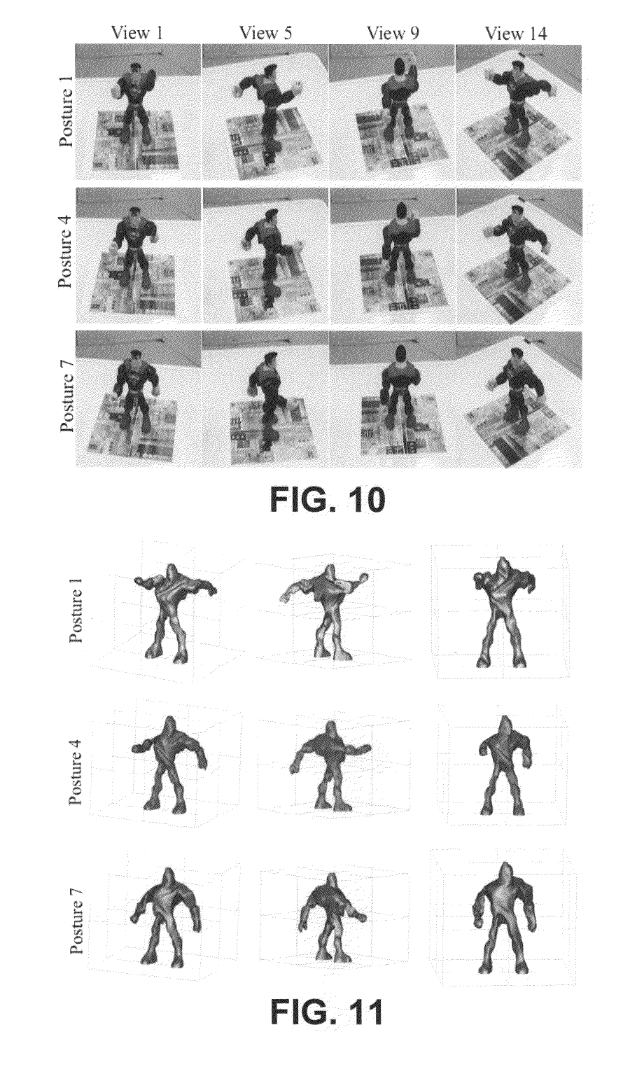

To quantitatively analyze the above-described process, an experiment was conducted in which several monocular sequences of an object were obtained. In each flyby of the camera, the object was kept stationary but the posture (arm position) of the object was incrementally changed between flybys. Because the object was kept stationary, the sequences are referred to herein as rigid sequences. Each rigid sequence consisted of 14 views of the object with a different arm position at a resolution of 480×720 with the object occupying a region of approximately 150×150 pixels. FIG. 10 illustrates example images from three of the seven rigid sequences (i.e., rigid sequences 1, 4, and 7). The image data from the rigid sequences was then used to obtain seven rigid reconstructions of the object, three of which are shown in FIG. 11.

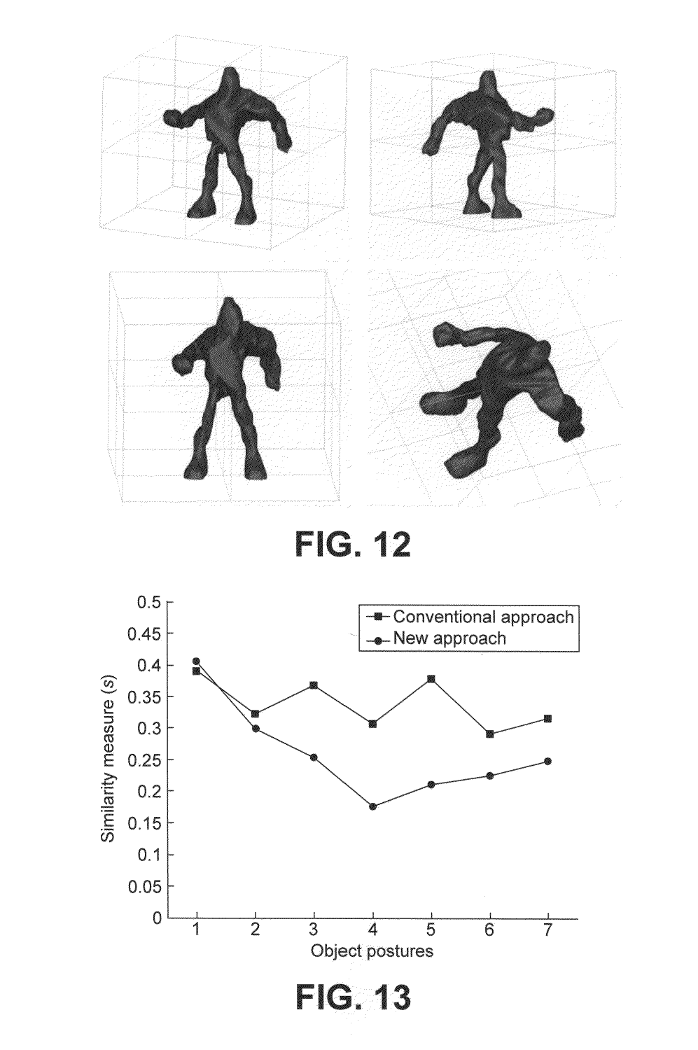

A monocular sequence of a non-rigidly deforming object was assembled by selecting two views from each rigid sequence in order, thereby creating a set of fourteen views of the object as it changes posture. Reconstruction on this assembled non-rigid, monocular sequence was performed using the occupancy deblurring approach described above and the visualization of the results is shown in FIG. 12. In that figure, the arms of the object are accurately reconstructed instead of being carved out as when traditional visual hull intersection is used. For quantitative analysis, the reconstruction results were compared with each of the seven reconstructions from the rigid sequences. All the reconstructions were aligned in three dimensions (with respect to the ground plane coordinate system) and the similarity was evaluated using a measure of the ratio of overlapping and non-overlapping voxels in the three-dimensional shapes. The similarity measure is described as:

$${S}_{i} = {( \frac{{\sum }_{∀ v ∈ {ℝ}^{3}}^{ } ( ( v ∈ {O}_{test} ) ⊕ ( v ∈ {O}_{rig}^{i} ) )}{{\sum }_{∀ v ∈ {ℝ}^{3}}^{ } ( ( v ∈ {O}_{test} ) ⋀ ( v ∈ {O}_{rig}^{i} ) )} )}^{2} , \qquad [ Equation 4 ]$$

where ν is a voxel in the voxel space [symbol] , Oₜₑₛₜ is the three-dimensional reconstruction that needs to be compared with, Q_{rig}ⁱ the visual hull reconstruction from ith rigid sequence. Sᵢ is the similarity score, i.e. the square of the fraction of non-overlapping to overlapping voxels that are a part of the reconstructions, wherein the closer Sᵢ is to zero greater the similarity. Shown in FIG. 13 are plots of the similarity measure. For the traditional visual hull reconstruction, the similarity is consistently quite low. This is expected since the moving parts of the object (arms) are carved out by the visual hull intersection. For the approach disclosed herein, however, there is a clear dip in the similarity measure value at rigid shape 4, demonstrating quantitatively that the result of using the disclosed approach is most similar to this shape.

### Example System

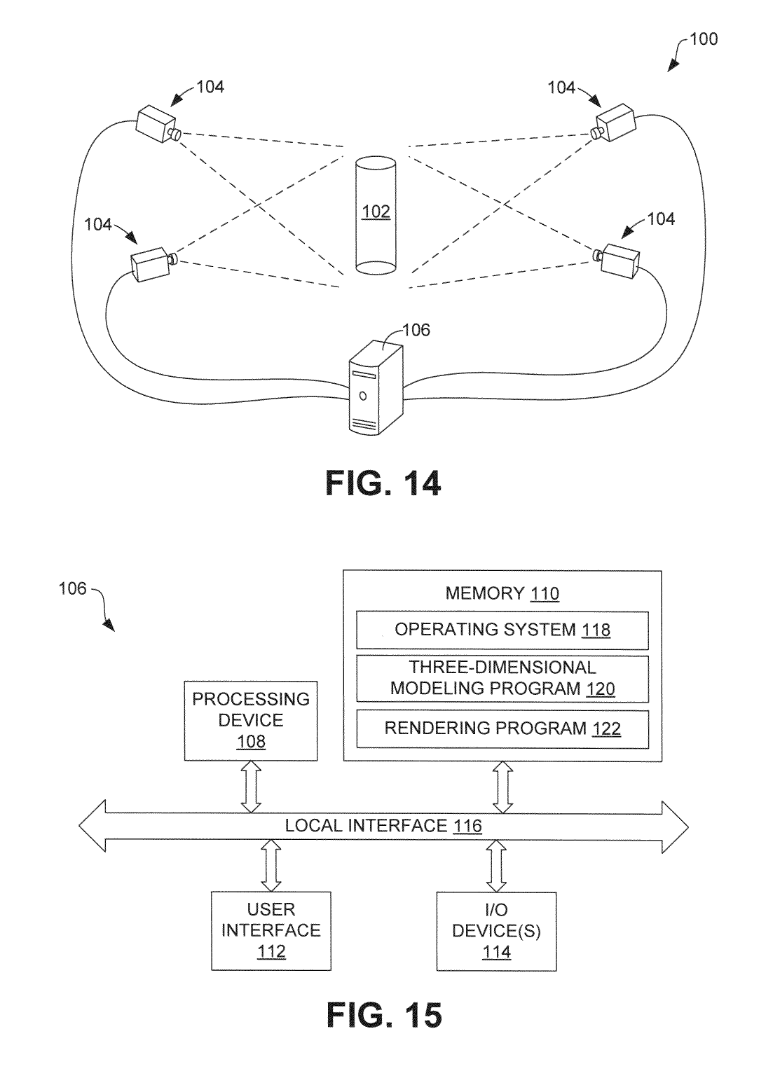

FIG. 14 illustrates an example system 100 that can be used to perform three-dimensional modeling of moving objects, such as example object 102. As indicated in that figure, the system 100 comprises at least one camera 104 that is communicatively coupled (either with a wired or wireless connection) to a computer system 106. Although the computer system 106 is illustrated in FIG. 14 as a single computing device, the computing system can comprise multiple computing devices that work in conjunction to perform or assist with the three-dimensional modeling.

FIG. 15 illustrates an example architecture for the computer system 106 shown in FIG. 14. As indicated in FIG. 15, the computer system 106 comprises a processing device 108, memory 110, a user interface 112, and at least one input/output (I/O) device 114, each of which is connected to a local interface 116.

The processing device 108 can comprise a central processing unit (CPU) that controls the overall operation of the computer system 106 and one or more graphics processor units (GPUs) for graphics rendering. The memory 110 includes any one of or a combination of volatile memory elements (e.g., RAM) and nonvolatile memory elements (e.g., hard disk, ROM, etc.) that store code that can be executed by the processing device 108.

The user interface 112 comprises the components with which a user interacts with the computer system 106. The user interface 112 can comprise conventional computer interface devices, such as a keyboard, a mouse, and a computer monitor. The one or more I/O devices 114 are adapted to facilitate communications with other devices and may include one or more communication components such as a modulator/demodulator (e.g., modem), wireless (e.g., radio frequency (RF)) transceiver, network card, etc.

The memory 110 (i.e., a computer-readable medium) comprises various programs (i.e., logic) including an operating system 118 and three-dimensional modeling system 120. The operating system 118 controls the execution of other programs and provides scheduling, input-output control, file and data management, memory management, and communication control and related services. The three-dimensional modeling system 120 comprises one or more algorithms and/or programs that are used to model a three-dimensional moving object from two-dimensional views in the manner described in the foregoing. Furthermore, memory 110 comprises a graphics rendering program 122 used to render surfaces computed using the three-dimensional modeling system 120.

Various code (i.e., logic) has been described in this disclosure. Such code can be stored on any computer-readable medium for use by or in connection with any computer-related system or method. In the context of this document, a “computer-readable medium” is an electronic, magnetic, optical, or other physical device or means that contains or stores code, such as a computer program, for use by or in connection with a computer-related system or method. The code can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

We claim:

1. A method for three-dimensionally modeling a moving object, the method comprising:
capturing sequential images of the moving object from multiple different viewpoints to obtain multiple views of the moving object over time;
identifying silhouettes of the moving object in each view, each silhouette comprising a plurality of silhouette boundary pixels;
determining the location in each view of a temporal occupancy point for each silhouette boundary pixel, each temporal occupancy point being the estimated localization of a three-dimensional scene point that gave rise to its associated silhouette boundary pixel;
generating blurred occupancy images that comprise silhouettes of the moving object composed of the temporal occupancy points;
deblurring the blurred occupancy images to generate deblurred occupancy maps of the moving object; and
reconstructing the moving object by performing visual hull intersection using the blurred occupancy maps to generate a three-dimensional model of the moving object.

2. The method of claim 1, wherein capturing sequential images comprises capturing sequential images of the moving object with a single monocular camera.

3. The method claim 1, wherein determining the location in each view of a temporal occupancy point first comprises identifying the silhouette boundary pixels by uniformly sampling pixels at the boundaries of the silhouettes of each view.

4. The method of claim 1, wherein determining the location in each view of a temporal occupancy point comprises first determining a temporal bounding edge for each silhouette boundary pixel in each view.

5. The method of claim 4, wherein determining a temporal bounding edge comprises, as to each silhouette boundary pixel, transforming the silhouette boundary pixel to each of the views using multiple plane homographies.

6. The method of claim 5, wherein transforming the silhouette boundary pixel comprises warping the silhouette boundary pixel to each other view with the homographies induced by successive parallel planes.

7. The method of claim 6, wherein determining a temporal bounding edge further comprises incrementing a spacing parameter that identifies the spacing between the successive parallel planes, and selecting the range of the spacing parameter for which the silhouette boundary pixel warps to within the largest number of silhouettes across the views.

8. The method of claim 7, wherein determining the location in each view of a temporal occupancy point further comprises identifying a warped location associated with the silhouette boundary pixel having a minimum color variance relative to the silhouette boundary pixel, that warped location being the location of the temporal occupancy point.

9. The method of claim 1, further comprising determining an occupancy duration for each silhouette boundary pixel and storing an occupancy duration value for each temporal occupancy point associated with each silhouette boundary pixel.

10. The method of claim 9, wherein generating a set of blurred occupancy images comprises using the occupancy duration values to set the pixel intensity of each temporal occupancy point in each blurred occupancy image.

11. The method of claim 1, wherein reconstructing the moving object using visual hull intersection comprises:
(a) designating one of the deblurred occupancy maps as a reference view;
(b) warping the other deblurred occupancy maps to the reference view;
(c) fusing the warped deblurred occupancy maps to obtain a cross-sectional slice of a visual hull of the moving object that lies in a reference plane;

12. The method of claim 11, wherein reconstructing the moving object using visual hull intersection further comprises:
(d) estimating further cross-sectional slices of the visual hull parallel to the first slice;
(e) stacking the slices on top of each other;
(f) computing an object surface from the slice data; and
(g) rendering the object surface.

13. A method for three-dimensionally modeling a moving object, the method comprising:
capturing sequential images of the moving object from multiple different viewpoints to obtain multiple views of the moving object over time;
identifying silhouettes of the moving object in each view;
uniformly sampling pixels at the boundaries of the silhouettes of each view to identify silhouette boundary pixels;
determining a temporal bounding edge for each silhouette boundary pixel in each other view;
determining an occupancy duration for each silhouette boundary pixel, the occupancy duration providing a measure of the fraction of time instances in which a ray along which the temporal bounding edge extends projects to within the silhouettes of the views;
determining the location in each view of a temporal occupancy point for each silhouette boundary pixel, each temporal occupancy point lying on a temporal bounding edge and being the estimated localization of a three-dimensional scene point that gave rise to its associated silhouette boundary pixel;
storing an occupancy duration value indicative of the determined occupancy duration for each temporal occupancy point;
generating blurred occupancy images that comprise silhouettes of the moving object composed of the temporal occupancy points and using the occupancy duration values to determine pixel intensity for the temporal occupancy points;
deblurring the blurred occupancy images to generate deblurred occupancy maps of the moving object; and
reconstructing the moving object by performing visual hull intersection using the blurred occupancy maps to generate a three-dimensional model of the moving object.

14. The method of claim 13, wherein capturing sequential images comprises capturing sequential images of the moving object with a single monocular camera.

15. The method of claim 14, wherein determining a temporal bounding edge comprises, as to each silhouette boundary pixel, transforming the silhouette boundary pixel to each of the views using multiple plane homographies.

16. The method of claim 15, wherein transforming the silhouette boundary pixel comprises warping the silhouette boundary pixel to each other view with the homographies induced by successive parallel planes.

17. The method of claim 16, wherein determining a temporal bounding edge further comprises incrementing a spacing parameter that identifies the spacing between the successive parallel planes, and selecting the range of the spacing parameter for which the silhouette boundary pixel warps to within the largest number of silhouettes across the views.

18. The method of claim 17, wherein determining the location in each view of a temporal occupancy point comprises determining identifying a warped location associated with the silhouette boundary pixel having minimum color variance relative to the silhouette boundary pixel that warped location being the location of the temporal occupancy point.

19. The method of claim 13, wherein reconstructing the moving object using visual hull intersection comprises:
(a) designating one of the deblurred occupancy maps as a reference view;
(b) warping the other deblurred occupancy maps to the reference view;
(c) fusing the warped deblurred occupancy maps to obtain a cross-sectional slice of a visual hull of the moving object that lies in a reference plane;

20. The method of claim 20, wherein reconstructing the moving object using visual hull intersection further comprises:
(d) estimating further cross-sectional slices of the visual hull parallel to the first slice;
(e) stacking the slices on top of each other;
(f) computing an object surface from the slice data; and
(g) rendering the object surface.

21. A computer-readable medium comprising:
logic configured to receive sequential views of a moving object captured from multiple different viewpoints;
logic configured to identify silhouettes of the moving object in each view, each silhouette comprising a plurality of silhouette boundary pixels;
logic configured to determine the location in each view of a temporal occupancy point for each silhouette boundary pixel, each temporal occupancy point being the estimated localization of a three-dimensional scene point that gave rise to its associated silhouette boundary pixel;
logic configured to generate blurred occupancy images that comprise silhouettes of the moving object composed of the temporal occupancy points;
logic configured to deblur the blurred occupancy images to generate deblurred occupancy maps of the moving object; and
logic configured to reconstruct the moving object by performing visual hull intersection using the blurred occupancy maps to generate a three-dimensional model of the moving object.

22. The computer-readable medium claim 1, wherein the logic configured to determine the location in each view of a temporal occupancy point comprises logic configured to first identify the silhouette boundary pixels by uniformly sampling pixels at the boundaries of the silhouettes of each view.

23. The computer-readable medium of claim 1, wherein the logic configured to determine the location in each view of a temporal occupancy point comprises the logic configured to first determine a temporal bounding edge for each silhouette boundary pixel in each view.

24. The computer-readable medium of claim 23, wherein the logic configured to determine a temporal bounding edge comprises logic configured to, as to each silhouette boundary pixel, transform the silhouette boundary pixel to each of the views using multiple plane homographies.

25. The computer-readable medium of claim 24, wherein the logic configured to transform the silhouette boundary pixel comprises the logic configured to warp the silhouette boundary pixel to each other view with the homographies induced by successive parallel planes.

26. The computer-readable medium of claim 25, wherein the logic configured to determine a temporal bounding edge comprises the logic configured to increment a spacing parameter that identifies the spacing between the successive parallel planes and select the range of the spacing parameter for which the silhouette boundary pixel warps to within the largest number of silhouettes in the views.

27. The computer-readable medium of claim 26, wherein the logic configured to determine the location in each view of a temporal occupancy point comprises the logic configured to identify a warped location associated with the silhouette boundary pixel that has a minimum color variance relative to the silhouette boundary pixel, that location being the location of the temporal occupancy point.

28. The computer-readable medium of claim 13, further comprising logic configured to determine an occupancy duration for each silhouette boundary pixel and store an occupancy duration value for each temporal occupancy point associated with each silhouette boundary pixel.

29. The computer-readable medium of claim 28, wherein the logic configured to generate a set of blurred occupancy images comprises the logic configured to use the occupancy duration values to set the pixel intensity of each temporal occupancy point in each blurred occupancy image.
